(19) United States
(12) Patent Application Publication
(10) Pub. No.: US 2016/0216839 A1
(43) Pub. Date: Jul. 28, 2016

(54) DISPLAY DEVICE AND ELECTRONIC DEVICE INCLUDING THE SAME

(71) Applicant: Samsung Display Co., Ltd., Yongin-si (KR)

(72) Inventors: Su Hyeong PARK, Gyeongju-si (KR); Ho Yong JUNG, Seongnam-si (KR); Jun-Woo HONG, Cheonan-si (KR); Joon-Chul GOH, Hwaseong-si (KR); Mun-San PARK, Hwaseong-si (KR); Ho Seok SON, Anyang-si (KR)

(21) Appl. No.: 14/861,840

(22) Filed: Sep. 22, 2015

(30) Foreign Application Priority Data
Jan. 22, 2015 (KR) 10-2015-0010838

(51) Int. Cl. G06F 3/041; G06F 3/044

(52) U.S. Cl. CPC G06F 3/0418; G06F 3/0412; G06F 3/044

(57) ABSTRACT

A display device includes: a processor configured to receive first image data for a display panel from an external system, determine a touch path based on a touch event generated by a touch sensor panel, and output second image data obtained by using the touch path to add overlay data to the first image data; and a control signal generating unit configured to generate a control signal for controlling an operation timing of a gate driver and a data driver, and operate in an interlace mode when the second image data is output to the display panel.

### CROSS-REFERENCE TO RELATED APPLICATION

This application claims priority to and the benefit of Korean Patent Application No. 10-2015-0010838 filed in the Korean Intellectual Property Office on Jan. 22, 2015, the entire contents of which are incorporated herein by reference.

### BACKGROUND

(a) Field

The present disclosure relates to a display device and an electronic device including the same.

(b) Description of the Related Art

A display panel integrated or combined to a touch sensor panel provides an interaction system to touch-available electronic devices such as cellular phones, tablet computers, laptop computers, desktop computers, and the like. In an electronic device, when a graphic image is displayed on a display panel, a user may touch the screen (using an active stylus, a passive stylus, or a part of his or her body such as a finger, for example) to interact with the electronic device, thus providing intuitional user interface.

A touch event detected by a touch sensor panel is typically processed by high-level application software operated in an application processor (AP) of an electronic device.

Until the touch event detected by the touch sensor panel is processed by the AP and a corresponding response is displayed on a display device, a long latency occurs due to numerous processing steps between the touch sensor panel and the AP, and also due to non-deterministic processing time in the AP (including delays due to other calculation tasks performed by the AP). This long latency reduces responsiveness of the electronic device with respect to a user's touch input.

Thus, most users of electronic devices may detect a delay from about tens of milliseconds to hundreds of milliseconds, and in such cases the devices cannot provide immediate feedback to a users' input, which may lead to an increase in user's dissatisfaction with the device.

The above information disclosed in this Background section is only for enhancement of understanding of the background of the disclosure and therefore it may contain information that does not form the prior art that is already known to a person of ordinary skill in the art.

### SUMMARY

A display lag according to a touch input in an electronic device having a touch input device is reduced.

In one aspect, a display device includes: a touch sensor panel; a display panel including a plurality of pixels formed in every pixel region defined by a plurality of gate lines and a plurality of data lines; a processor configured to receive first image data for the display panel from an external system, determine a touch path based on a touch event generated by the touch sensor panel, and output second image data obtained by using the touch path to add overlay data to the first image data; a gate driver configured to supply a scan signal to the plurality of gate lines; a data driver configured to supply a data signal corresponding to the second image data to the plurality of data lines according to the scan signal; and a control signal generating unit configured to generate a control signal for controlling an operation timing of the gate driver and the data driver, and operate in an interlace mode when the second image data is output to the display panel to control the gate driver such that the scan signal is supplied to every other line.

In another aspect, an electronic device includes: an application processor; a touch sensor panel; a display panel including a plurality of pixels formed in every pixel region defined by a plurality of gate lines and a plurality of data lines; a processor configured to receive first image data for the display panel from the application processor, determine a touch path based on a touch event generated by the touch sensor panel, and output second image data obtained by using the touch path to add overlay data to the first image data; a gate driver configured to supply a scan signal to the plurality of gate lines; a data driver configured to supply a data signal corresponding to the second image data to the plurality of data lines according to the scan signal; and a control signal generating unit configured to generate a control signal for controlling an operation timing of the gate driver and the data driver, and operate in an interlace mode when the second image data is output to the display panel to control the gate driver such that the scan signal is supplied to every other line.

According to an exemplary embodiment of the present disclosure, a display lag between a touch input device and a display device in an electronic device having the touch input device may be reduced.

### BRIEF DESCRIPTION OF THE DRAWINGS

FIG. 1 is a view illustrating a response of an electronic device including a touch input processing apparatus.

FIG. 2 is a schematic block diagram of the electronic device according to an exemplary embodiment of the present disclosure.

FIG. 3 is a schematic block diagram of a timing controller according to an exemplary embodiment of the present disclosure.

FIG. 4 is a schematic block diagram of an overlay system according to an exemplary embodiment of the present disclosure.

FIG. 5 is a view schematically illustrating generation of low-standby time image data in the overlay system according to an exemplary embodiment of the present disclosure.

FIG. 6 is a flow chart illustrating a method for reducing a display lag of a display module according to an exemplary embodiment of the present disclosure.

FIG. 7 is a view illustrating a reduction in a display lag of the electronic device according to an exemplary embodiment of the present disclosure.

### DETAILED DESCRIPTION OF THE EMBODIMENTS

In the following detailed description, only certain exemplary embodiments of the present disclosure have been shown and described, simply by way of illustration. As those skilled in the art would realize, the described embodiments may be modified in various different ways, all without departing from the spirit or scope of the present disclosure. Accordingly, the drawings and description are to be regarded as illustrative in nature and not restrictive. Like reference numerals designate like elements throughout the specification.

A response lag about a user interface (UI) is a common cause of discontent with touch-available electronic devices including a touch input processing apparatuses. In the current touch-available electronic devices, typically, tens of milliseconds to hundreds of milliseconds are taken for updating a display in response to a touch behavior.

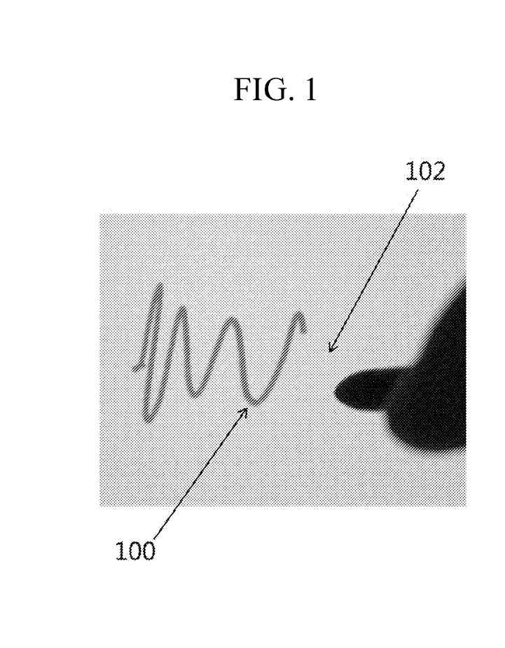

FIG. 1 is a view illustrating a response of an electronic device including a touch input processing apparatus. As illustrated in FIG. 1, when a stylus moves in contact with a screen, there is a gap between a touch position of the stylus and a finally drawn portion of a displayed line 100. That is, a conspicuous display lag occurs between the user's touch and the displayed line 100. Also, a similar display lag occurs even when the user touches the screen with his or her finger.

In an exemplary embodiment of the present disclosure, when a touch event occurs, an application processor (AP) displays an image overlaying overlay data based on a touch position (hereinafter, referred to as a “low-standby time image”) before an image (hereinafter, referred to as a “high-standby time image”) rendered in relation to the touch event. Thus, a gap between the user's touch position (no matter whether a finger, a stylus, or any other implement is used) on the screen and the drawn line may be reduced, and thus, a sensed display lag may be reduced.

Even though the display lag generated when the touch event is processed by the AP is reduced by first displaying an image of the low-standby time on the basis of the touch position as described above, a physical display lag based on a screen update rate of a display module still remains. For example, in the case of a display module having a refresh rate of 60 frames per second (FPS), a physical delay of approximately 16.7 ms inevitably occurs for a low-standby time image to be updated on the screen no matter how fast the process rate of the low-standby time image is.

Thus, in an exemplary embodiment of the present disclosure, when a low-standby time image based on the touch position is output to a display module, the display module is driven in an interlace mode to reduce a physical display lag.

In the present disclosure, when used as a verb, “overlay” refers to combining an image (for example, an image rendered by the AP) and additional image data that replaces (or overlays) a portion of the original image with the additional image data. When used as a noun, “overlay” may refer to the additional image data that appears in a combined display image.

Hereinafter, a display device and an electronic device including the same according to an exemplary embodiment of the present disclosure will be described in detail with reference to the relevant drawings.

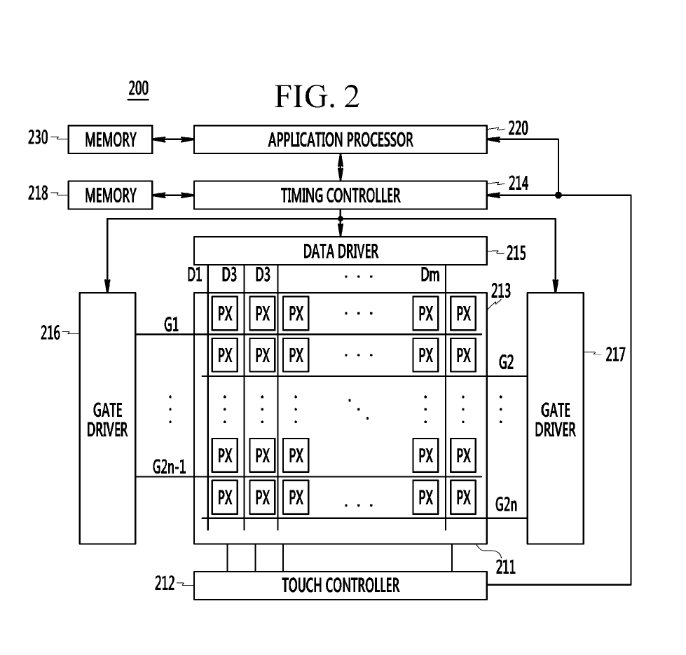

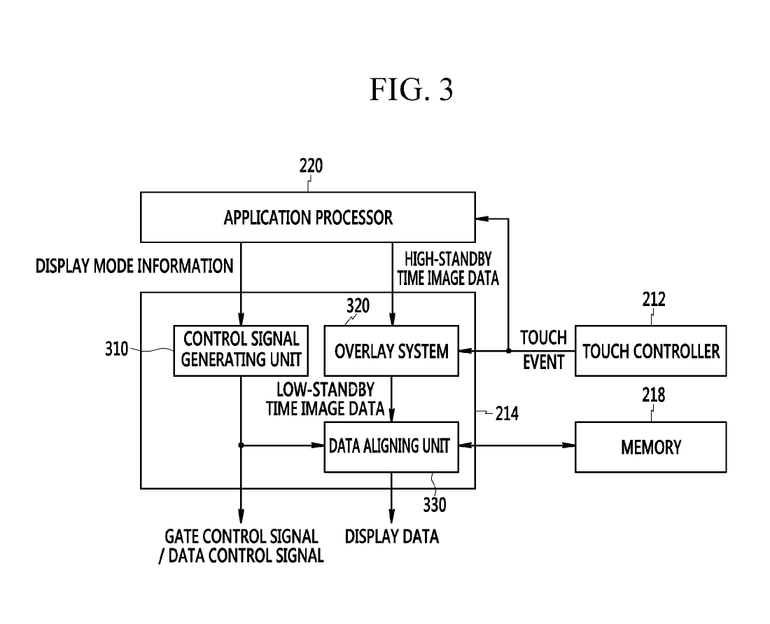

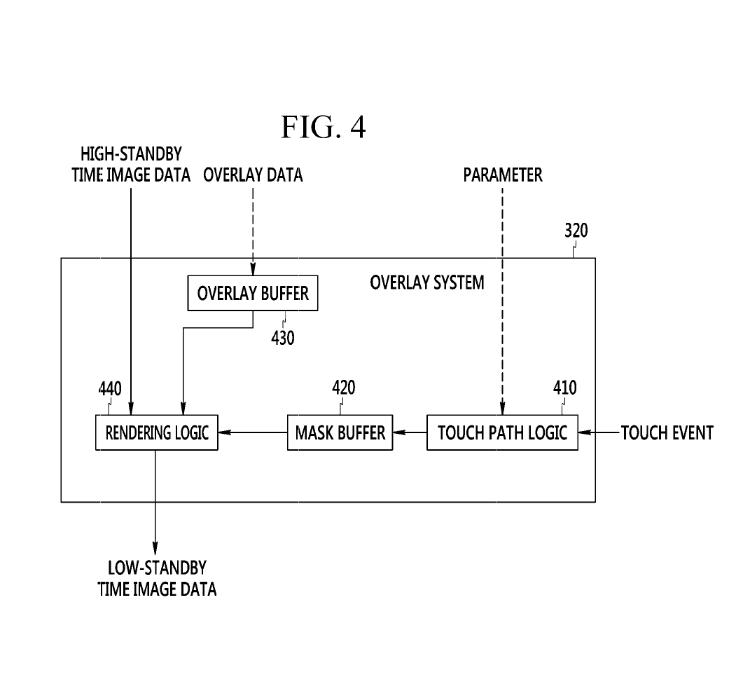

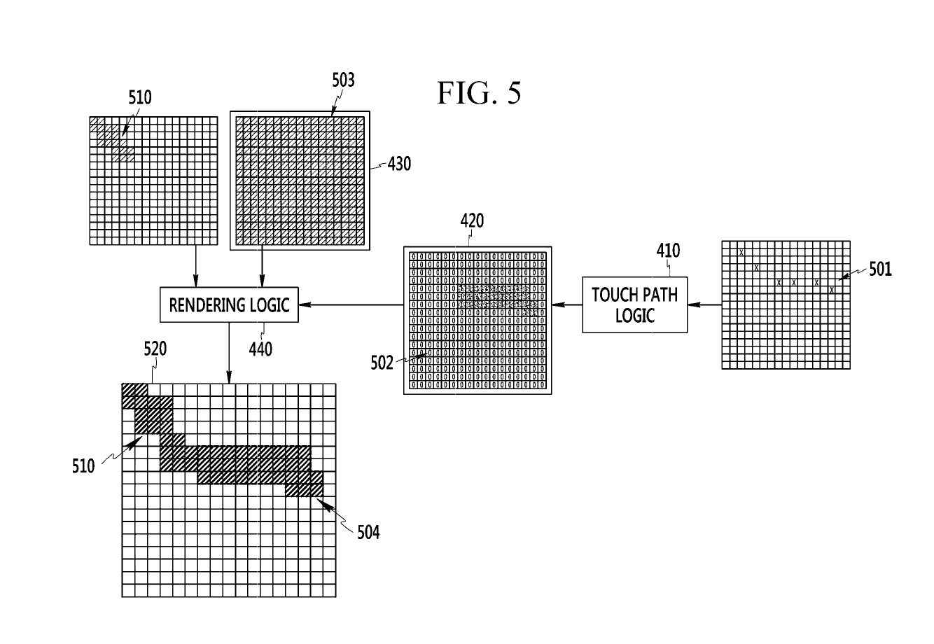

FIG. 2 is a schematic block diagram of the electronic device according to an exemplary embodiment of the present disclosure. FIG. 3 is a schematic block diagram of a timing controller according to an exemplary embodiment of the present disclosure. FIG. 4 is a schematic block diagram of an overlay system according to an exemplary embodiment of the present disclosure. FIG. 5 is a view schematically illustrating generation of low-standby time image data in the overlay system according to an exemplary embodiment of the present disclosure.

Referring to FIG. 2, an electronic device 200 may include a display module, an Application Processor (AP) 220, and a memory 230.

According to an exemplary embodiment of the present disclosure, the display module may include a touch sensor panel 211, a touch controller 212, a display panel 213, a timing controller 214, a data driver 215, and gate drivers 216 and 217

The display module may further include a memory 218 in addition to memory 230 of electronic device 200.

In an exemplary embodiment of the present disclosure, a case in which the touch sensor panel 211, the touch controller 212, the display panel, the timing controller 214, the data driver 215, and the gate drivers 216 and 217 are components of the display module, and in which these components are components that are separate from the AP 220 will be described as an example, but the present inventive concept is not limited thereto. In another exemplary embodiment, the touch sensor panel 211, the touch controller 212, the display panel 213, the timing controller 214, the data driver 215, the gate drivers 216 and 217, and combinations thereof may be positioned in separate modules or may be combined with the AP 220.

Also, in FIG. 2, the touch controller 212 is illustrated as a physically separate component, but in some exemplary embodiments, the touch controller 212 may be part of any other integrated circuit (IC). For example, the touch controller 212 may be realized within the same IC as that of the AP 220 and/or the timing controller 214.

Referring to FIG. 2, the touch sensor panel 211 detects a user's touch and generates a touch signal supplied to the touch controller 212.

The touch sensor panel 211 detects the user's touch using a part (e.g., finger) of the user, a certain type of pointing implement such as a stylus, and the like. In an exemplary embodiment of the present disclosure, the “pointing implement” refers to an object that may be detected by the touch sensor panel 211, including a device (active stylus or passive stylus) and a part (finger or head) of the user.

As the touch sensor panel 211, a certain panel among various types of touch panels such as a resistive touch panel, a surface acoustic wave touch panel, a capacitive touch panel, an infrared touch panel, an optical touch panel, and the like, may be used.

Methods for configuring the touch sensor panel 211 in the display module include an on-cell type configuring method, an in-cell type configuring method, a hybrid in-cell type configuring method, and the like.

When a touch occurs on the touch sensor panel 211 by the pointing implement, the touch controller 212 receives a touch signal from the touch sensor panel 211. The touch signal output from the touch sensor panel 211 corresponds to data supplied by the touch sensor panel 211, such as a measurement value of capacitance, a voltage, or a current in each position of the touch sensor panel 211.

The touch controller 212 processes the touch signal received from the touch sensor panel 211 and outputs a touch event, such as touch coordinates, to the AP 220 and the timing controller 214. The touch event output from the touch controller 212 may be a stream of the data value corresponding to a position from which the user's touch has been detected (for example, a change in capacitance, a voltage, and a current having a value sufficient for detecting the touch event). In some exemplary embodiments, the touch event may include pressure data indicating the amount of pressure applied to the touch sensor panel 211.

When the touch event is received from the touch controller 212, the AP 220 processes the touch event. In response to processing of the touch event received from the touch controller 212, application software executed in the AP 220 renders high-standby time image data (or image frame) to be displayed on the display panel 213.

The high-standby time image data rendered by the AP 220 is stored in the memory 230 and transferred to the timing controller 214 by the AP 220.

The AP 220 selects either a progressive mode or an interlace mode, as a display mode of the display panel 213.

The progressive mode is a display mode in which data of every horizontal line constituting one frame is sequentially scanned. In the progressive mode, the display module updates a screen in units of frames.

The interlace mode is a display mode in which every other horizontal line constituting one frame are scanned, rather than being sequentially scanned. In the interface mode, one frame is divided into a plurality of fields, and the screen of the display module is updated in units of fields.

In the interlace mode, each field includes only partial horizontal lines forming a frame, having low resolution, compared with a frame, but the time required for updating a screen is shorter than that for updating one frame. Thus, the interlace mode has a short screen update period, compared with a progressive mode.

The AP 220 selects a display mode of the display panel 213 according to application software being currently executed.

In the case of an application program in which reaction time is more important than display quality, like a note application, for example, the AP 220 selects an interlace mode having a relatively small display lag as a display mode. Also, for example, in the case of an application program in which display quality is more important factor than a reaction time, like a video play application, the AP 220 may select a progressive mode having relatively good display quality as a display mode.

In an exemplary embodiment of the present disclosure, when application software is executed that detects that a line corresponding to a touch path is drawn on the screen in response to the touch event, the AP 220 selects the interlace mode as a display mode to reduce a display lag.

As the display mode is selected, the AP 220 outputs display mode information regarding the selected display mode to the timing controller 214.

The AP 220 may include a central processing unit (CPU), a graphic processing unit (GPU), and the like.

The display panel 213 includes a plurality of pixels PX formed in each pixel region defined as a plurality of gate lines G1 to G2n and a plurality of data lines D1 to Dm intersect.

The timing controller 214 generates a control signal for controlling the data driver 215, and the gate drivers 216 and 217 use a timing signal input from the external system (AP 220). Also, the timing controller 214 receives image data from the external system (AP 220) and transmits the same to the data driver 215.

Referring to FIG. 3, the timing controller 214 according to an exemplary embodiment of the present disclosure may include a control signal generating unit 310, an overlay system 320, and a data aligning unit 330.

The control signal generating unit 310 receives signals required for generating a control signal such as a vertical synchronization signal Vsync, a horizontal synchronization signal Hsync, a data enable signal DE, and the like, from the external system (AP 220). The control signal generating unit 310 generates a data control signal for controlling the operation timing of the data driver 215, and a gate control signal for controlling the operation timing of the gate drivers 216 and 217, by using received signals. The vertical synchronization signal is a signal for distinguishing each frame and the horizontal synchronization signal is a signal for distinguishing each horizontal line constituting a frame. One frame time for image data corresponds a vertical period based on a vertical synchronization signal, and a plurality of horizontal periods are repeated in one vertical period.

The control signal generating unit 310 receives display mode information from the external system (AP 220), and generates a control signal for driving the data driver 215 and the gate drivers 216 and 217 in the progressive mode or the interlace mode on the basis of the display mode information.

When display mode information indicating the progressive mode is received from the AP 220, the control signal generating unit 310 generates a gate control signal such that a scan signal is sequentially supplied to all of the gate lines.

When display mode information indicating an interlace mode is received from the AP 220, the control signal generating unit 310 generates a gate control signal such that a scan signal is supplied to every other line

When the gate drivers 216 and 217 operate in a progressive mode or an interlace mode, the control signal generating unit 310 supplies a data control signal to the data driver 215 such that a corresponding data signal is output in the order in which a scan signal is supplied.

The overlay system 320 is connected to the touch controller 212 and receives a touch event from the touch controller 212. The overlay system 320 is connected to the AP 220 and overlays an image based on high-standby time image data of the touch event from the AP 220.

Until the touch event from the touch controller 212 is transmitted to the AP 220 and processed and a corresponding response image (high-standby time image data) is output, a considerable lag occurs.

Thus, the overlay system 320 internally generates an image based on the touch event before receiving the response image with respect to the touch event from the AP 220. And then, the overlay system 320 overlays the image based on the touch event on the high-standby time image data previously received from the AP 220. Thus, a gap generated between the image and the touch device along the touch path of the user to be displayed as a corresponding response image (for example, line drawing) may be narrowed, and a display lag sensed by the user may be reduced.

Referring to FIGS. 4 and 5, the overlay system 320 according to an exemplary embodiment of the present disclosure includes a touch path logic 410, a mask buffer 420, an overlay buffer 430, and a rendering logic 440

The touch path logic 410 is connected to the touch controller 212, and receives a touch event 501 from the touch controller 212. The touch path logic 410 generates an estimated touch path from the touch event 501 transmitted from the touch controller 212. For example, the touch path logic 410 may generate an estimated touch path by interpolating and/or extrapolating continuous positions of the touch event 501.

The touch path logic 410 may be connected to the AP 220 and receive a configuration parameter[s]. The parameter[s] received from the AP 220 determines characteristics of an estimated touch path when the touch path is generated. The parameter[s] received from the AP 220 may include a width of the estimate touch path, a style of a generated line segment such as a single linear segment and a curved line, a display region (e.g., an active drawing region) in which a path is allowed, and/or a style of a rendering operation (e.g., an antialiasing operation, a smoothing operation, transparency, etc.), and the present inventive concept is not limited thereto.

The touch path logic 410 is connected to the mask buffer 420 used by the rendering logic 440, and generates mask data 502 stored in the mask buffer 420 on the basis of the estimated touch path and the parameter[s] received from the AP 220.

The mask data 502 is a matrix of numerical values. In the mask data 502, positions of the numerical values of the matrix correspond to positions of pixels of the display panel 213, and relative positions of values of the matrix correspond to relative positions of the pixels of the display panel 213. For example, the mask data 502 may be regarded as a 2D matrix corresponding to a 2D map of pixel positions of image data 520 output from the rendering logic 440.

Each of the numerical values of the mask data 502 indicate whether overlay data in each pixel position constituting the image data 520 is overlaid. For example, in the mask data 502, positions in which overlay data should be overlaid in the image data 520 may have a value set as a first value (for example, “1”) and positions in which overlay data should not be overlaid in the image data 520 may have a value set as a second value (for example, “0”) different from the first value.

The mask data 502 stored in the mask buffer 420 is updated to correspond to a newly estimated touch path whenever a new touch event is received from the touch path logic 410. Also, a value of at least a portion of the mask data 502 may be reset whenever new image data 510 is received from the AP 220.

The overlay buffer 430 is a memory device storing the overlay data 503 processed by the rendering logic 440. The overlay data 503 may be received from the AP 220 connected to the overlay buffer 430. The overlay data 503 may be created within the overlay system 320 without being input from the AP 220. The overlay data 503 may be a combination of data created within the overlay system 320 and the data input from the AP 220.

Characteristics (color, texture, transparency, and the like), of the overlay data 503 are determined by a desired output of the rendering logic 440. That is, the characteristics of the overlay data 503 may be identical to characteristics of a line included in the high-standby time image data. For example, when the application software draws a black line, the overlay data 503 may be provided by the AP 220 or may be internally generated by the overlay system 320 in order to include a black color (for example, all of the pixels have a black image) the same as the line drawn by the software.

The overlay buffer 430 supplies the stored overlay data 503 to the rendering logic 440.

The rendering logic 440 is connected to the AP 220 and the overlay buffer 430. The rendering logic 440 receives the new high-standby time image data 510 rendered by the AP 220 from the AP 220, and receives the overlay data 503 from the overlay buffer 430.

The rendering logic 440 combines or blends the overlay data 503 with the new image data 510 received from the AP 220 using to the values from the mask data 502. That is, the rendering logic 440 updates new image data 510 received from the AP 220 by using the overlay data 503 and a value in the mask data 502.

As each pixel of the image data 510 is processed by the rendering logic 440, the rendering logic 440 retrieves a value in the mask data 502 that corresponds to the location of the pixel in the image data 510, and performs a substitution of the image data 510 for the pixel with the overlay data 503 or a blending of the image data 510 for the pixel and the overlay data 503 in accordance with the value in the mask data 502 to output combined image data 520.

For example, the rendering logic 440 may select the output of the rendering logic 440 to be either the image data 510 or the overlay data 503 for each pixel of the combined display image 510 based on each value in the mask data 502.

Also for example, the rendering logic 440 may perform a blending (e.g., merging) of the overlay data 503 and the image data 510 such that the combined image data 520 takes on characteristics of both the overlay data 503 and the image data 510 based on each value in the mask data 502. In this case, the values in the mask data 502 may represent the level of blending (e.g., the level of transparency) to be rendered by the rendering logic 440.

Accordingly, the low-standby time image data 520 output from the rendering logic 440 may include a black line formed by positioning the image segment 510 (for example, the line drawn by application software operated in AP 220) from the AP 220 and the overlay image segment 504 determined by the mask data 502 and the overlay data 503 such that the image segment 510 and the overlay image segment 504 are close to each other.

In an exemplary embodiment, the touch path logic 410, the mask buffer 420, the overlay buffer 430, and the rendering logic 440 may be realized using different application specific integrated circuits (ASICs).

In another exemplary embodiment, in order to realize all the functions of the touch path logic 410, the mask buffer 420, the overlay buffer 430, and the rendering logic 440, a single ASIC may be used.

Also, in another exemplary embodiment, a field programmable gate array (FPGA) may be programmed to execute the functions of the touch path logic 410, the mask buffer 420, the overlay buffer 430, and the rendering logic 440.

Also, in another exemplary embodiment, a global processor such as an advanced RSIC machine (ARM) process, or the like, may be programmed to perform functions of each of the touch path logic 410, the mask buffer 420, the overlay buffer 430, and the rendering logic 440.

In another exemplary embodiment, functions of one or more of the touch path logic 410, the mask buffer 420, the overlay buffer 430, and the rendering logic 440 may be realized as components of the AP 220.

In FIG. 4, the touch path logic 410, the mask buffer 420, the overlay buffer 430, and the rendering logic 440 are illustrated as components of the timing controller 214, but an exemplary embodiment of the present disclosure is not limited thereto. In some exemplary embodiments, one or more of the touch path logic 410, the mask buffer 420, the overlay buffer 430, and the rendering logic 440 may be positioned within the touch controller 212 or the AP 220, or may be positioned as separate components, for example. These components or functions performed by these components may be positioned in different portions of a device. For example, the touch path logic 410 may be realized by the touch controller 212, and the overlay buffer 430 and the rendering logic 440 may be realized by the AP 220.

Referring back to FIG. 3, the overlay system 320 is connected to the data aligning unit 330, and supplies low-standby time image data 520 generated by the rendering logic 440 to the data aligning unit 330.

The data aligning unit 330 is connected to the overlay system 320 and receives low-standby time image data from the overlay system 320. Also, the data aligning unit 330 aligns image data received from the overlay system 320 according to the structure and characteristics of the display panel 217. That is, the data aligning unit 330 aligns image data received from the overlay system 320 in units of pixel rows (a data group outputtable within one horizontal period) and supplies the same to the data driver 215.

The image data (or display data) aligned by the data aligning unit 330 is supplied to the data driver 215 according to a scan signal supply timing of each horizontal line.

The data aligning unit 330 may supply data to the data driver 215 such that the panel 213 operates in the progressive mode or the interlace mode, according to display mode information received from the AP 220.

For example, when the display panel 213 operates in the interlace mode, the data aligning unit 330 supplies data to the data driving unit 215 such that the data driver 215 supplies a plurality of data signals to every other horizontal line (one pixel row).

Also, for example, when the display panel 213 operates in the progressive mode, the data aligning unit 330 supplies data to the data driver 215 such that the data driver 215 sequentially supplies a plurality of data signals to every horizontal line (pixel row).

In an exemplary embodiment, the AP 220 may supply high-standby time image data (please refer to reference numeral 510 of FIG. 5) in a frame form to the overlay system 320 regardless of display mode. Thus, the overlay system 320 generates low-standby time image data (please refer to reference numeral 520 of FIG. 5) in units of frames in the interlace mode. When the low-standby time image data is supplied in units of frames from the overlay system 320, the data aligning unit 330 divides one frame into a plurality of frames when the display panel 213 operates in the interlace mode. Data sequences divided into a plurality of fields by the data aligning unit 330 are stored in the memory 218, and the data aligning unit 330 reads corresponding data from the memory 218 according to the output order of each field, and supplies the read data to the data driver 215.

In another exemplary embodiment, when the display panel 213 operates in the interlace mode, the AP 220 divides high-standby time image data (please refer to reference numeral 510 of FIG. 5) into a plurality of fields in advance, and sequentially supplies image data corresponding to each field to the timing controller 214. Accordingly, the overlay system 320 generates low-standby time image data (please refer to reference numeral 520 of FIG. 5) in units of fields in the interlace mode. When the low-standby time image data is supplied in units of fields from the overlay system 320 in the interlace mode, the data aligning unit 330 aligns the low-standby time image data and supplies the aligned data to the data driver 215. In this case, the memory 218 may be omitted.

Also, in FIG. 3, it is illustrated that image data from the AP 220 is supplied to the data aligning unit 330 through the overlay system 320 regardless of display mode, as an example, but the exemplary embodiment of the present disclosure is not limited thereto. In some exemplary embodiments, when the display panel 213 operates in the progressive mode, the image data from the AP 220 may be directly supplied to the data aligning unit 330, without going through the overlay system 320.

Referring back to FIG. 2, the data driver 215 is connected to the data aligning unit 330 of the timing controller 214, and receives image data from the data aligning unit 330. The data driver 215 converts the image data input from the data aligning unit 330 into a data signal according to characteristics of the display panel 213, and outputs the converted data signal to each data line (D1 to Dm) of the display panel 217.

The data driver 215 receives data control signals such as a data enable signal, a horizontal start signal, and the like, from the control signal generating unit 310 of the timing controller 214. The data enable signal is a signal for distinguishing an active interval in which a data signal is substantially output to the display panel 213. In synchronization with the data control signal, the data driver 215 supplies a data signal to the data lines (D1 to Dm). The data driver 215 supplies a data signal for a single horizontal line to the data lines (D1 to Dm) at every horizontal period in which a scan signal is supplied to each gate line. That is, the data driver 215 supplies a plurality of data signals to a pixel row corresponding to the supplied scan signal according to a scan signal supply timing of each horizontal line.

The gate drivers 216 and 217 are connected to the control signal generating unit 310 of the timing controller 214, and receive a gate control signal from the control signal generating unit 310. The gate drivers 216 and 217 sequentially supply scan signals to each gate line (G1 to G2n) on the basis of the gate control signal.

In an exemplary embodiment, the display module includes a plurality of gate drivers 216 and 217, and gate lines constituting the display panel 213 are distinguishably connected to the plurality of gate drivers 216 and 217. That is, different gate lines are connected to the gate drivers 216 and 217, and gate lines are connected to the gate drivers 216 and 217 at at least every other line interval.

For example, as illustrated in FIG. 2, in a case in which two gate drivers are included in the display module, (2n-1)th (n is a natural number) gate lines (G1, G3, . . . , G2n-1) are connected to the first gate driver 216 and 2nth gate lines (G2, G4, . . . , G2n) are connected to the second gate driver 217.

Also, for example, in a case in which four gate drivers are included in the display module, (4n-3)th, (4n-2)th, (4n-1)th, and 4nth gate lines are connected to the first, second, third, and fourth gate drivers.

A timing at which the plurality of gate drivers 216 and 217 are driven may be controlled according to the display mode determined by the AP 220. When the display mode is a progressive mode, the plurality of gate drivers 216 and 217 are all driven to sequentially supply a scan signal to every gate line.

When the display mode is an interlace mode, the plurality of gate drivers 216 and 217 are sequentially driven to supply a scan signal to the gate lines.

In the interlace mode, one frame is divided into a plurality of fields and output, and each field is synchronized with the different gate drivers 216 and 217 and output. That is, in the interlace mode, each of the gate drivers 216 and 217 is synchronized according to the output timing of a corresponding field, and output a scan signal.

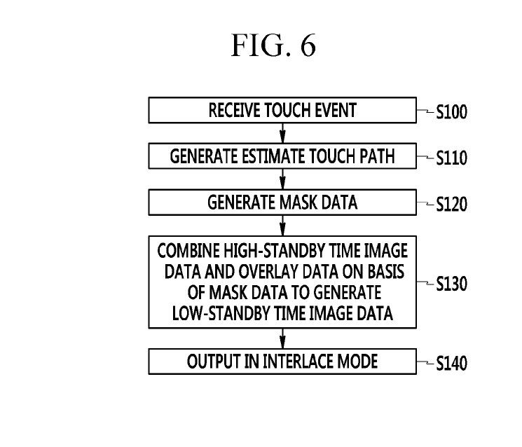

FIG. 6 is a flow chart illustrating a method for reducing a display lag of a display module according to an exemplary embodiment of the present disclosure.

Referring to FIG. 6, according to an exemplary embodiment of the present disclosure, the overlay system 320 receives a touch event from the touch controller 212 (S100). The overlay system 320 generates an estimated touch path (estimate touch path) from the touch event by interpolating or extrapolating the touch event (S110).

The overlay system 320 generates mask data from the estimated touch path (S120). Each value constituting the mask data indicates whether a pixel in a corresponding position is combined with overlay data. The mask data is stored in the mask buffer 420.

The overlay system 320 combines the overlay data and the high-standby time image data from the AP 220 on the basis of the mask data to generate a low-standby time image data to be transmitted to the display panel 217 (S130).

The low-standby time image data generated in step S130 may be aligned according to writing order. For example, the data aligning unit 330 divides low-standby time image data of one frame unit into a plurality of field units and aligns the same.

The low-standby time image data is supplied to the data driver 215 according to the writing order, and the data driver 215 may convert the low-standby time image data into a data signal and subsequently outputs the data signal to the display panel 213 in the interlace mode (S140).

At S140, the control signal generating unit 310 generates a gate control signal and a data control signal such that the display panel 213 operates in the interlace mode. Also, the data driver 215 supplies a plurality of data signals to a pixel row corresponding to the supplied scan signal according to a scan signal supply timing of each horizontal line.

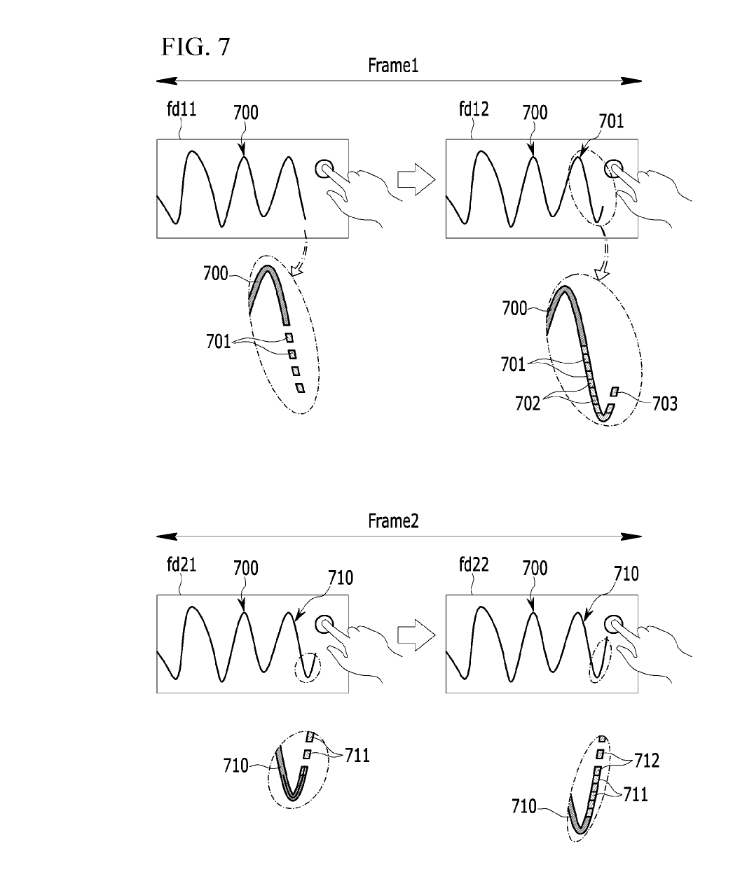

FIG. 7 is a view illustrating a reduction in a display lag of the electronic device according to an exemplary embodiment of the present disclosure, specifically illustrating an interlace mode in which a single frame is divided into two fields (an odd-numbered field and an even-numbered field) and updated.

Referring to FIG. 7, as a first field fd11 of a first frame (Frame1) is output to the display panel, a display line including an image segment 700 (for example, a line drawn by software) from the AP (please refer to reference numeral 220 of FIG. 2) and an overlay image segment 701 determined according to a touch path by the overlay system (please refer to reference numeral 320 of FIG. 3) is displayed on the screen. In this case, because the display panel is driven in the interlace mode, an overlay image segment 701 calculated by the overlay system 320 is an overlay image segment corresponding to even-numbered (or odd-numbered) horizontal lines.

Thereafter, as a second field fd12 of the first frame is output to the display panel, a display line including an image segment 700 from the AP and overlay image segments 701 and 702 determined by the overlay system by itself according to a touch path is displayed on the screen. In this case, because the display panel is driven in the interlace mode, the overlay image segments 701 and 702 calculated by the overlay system 320 may include the overlay image segment 701 corresponding to the even-numbered (or odd-numbered) horizontal lines output first and the overlay image segment 702 corresponding to the odd-numbered (or even-numbered) horizontal lines output next.

In general, the touch sensor panel 211 detects a touch event several times within one vertical period. Thus, even while the first field is being output, the overlay system 320 may receive a touch event and update the overlay image segment.

Thus, the second field fd12 of the first frame updated while the first field fd11 of the first frame is being output to the display panel may further include an overlay image segment 703 updated while the first field is being output, to the overlay image segment 702 calculated already when the first field is output.

As the high-standby time image data is updated by the AP 220, a second frame further includes an image segment 710 (for example, a line drawn by software) newly added by the AP (please refer to reference numeral 220 of FIG. 2).

Thus, when a first field fd21 and a second field fd22 of the second frame are output to the display panel, the overlay image segments 711 and 712 determined according to a touch path in the overlay system 330 are combined to the image segments 700 and 710 updated by the AP 220 and displayed on the screen. Here, the overlay image segments 701, 702, and 703 in the first frame are deleted from the second frame, and overlay image segments 711 and 712 continued from the newly added image segment 710 may be combined.

As described above, in an exemplary embodiment of the present disclosure, when a touch event occurs, low-standby time image data according to the touch path is first displayed before the high-standby time image data corresponding to the touch event is generated by the AP, a display lag felt by the user is reduced. Also, when the low-standby time image data is output to the display panel, the display panel is driven in the interlace mode to thereby reduce also a physical delay time due to a screen refresh speed of the display panel, whereby an overall system standby time may be reduced to enhance a display response speed.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A display device comprising:
a touch sensor panel;
a display panel including a plurality of pixels formed in a plurality of pixel regions defined by a plurality of gate lines and a plurality of data lines;
a processor configured to receive first image data for the display panel from an external system, determine a touch path based on a touch event generated by the touch sensor panel, and output second image data obtained by using the touch path to add overlay data to the first image data;
a gate driver configured to supply a scan signal to the plurality of gate lines;
a data driver configured to supply a data signal corresponding to the second image data to the plurality of data lines according to the scan signal; and
a control signal generating unit configured to generate a control signal for controlling an operation timing of the gate driver and the data driver, and operate in an interlace mode when the second image data is output to the display panel to control the gate driver such that the scan signal is supplied to every other line.

2. The display device of claim 1, wherein the processor includes:
a touch path logic configured to receive the touch event, determine the touch path based on the touch event, and generate mask data using the touch path; and
a rendering logic configured to receive the first image data and output the second image data obtained by using the mask data generated from the touch path to add the overlay data to the first image data.

3. The display device of claim 2, wherein:
the first image data includes a line displayed on the display panel, and
characteristics of the overlay data are identical to characteristics of the line.

4. The display device of claim 2, wherein:
the mask data includes a matrix of a plurality of numerical values,
positions of the numerical values of the matrix correspond to positions of pixels in the second image data, and
each numerical value specifies an overlay operation in a corresponding pixel.

5. The display device of claim 1, wherein the processor and the control signal generating unit are components of a timing controller.

6. An electronic device comprising:
an application processor:
a touch sensor panel;
a display panel including a plurality of pixels formed in a plurality of pixel regions defined by a plurality of gate lines and a plurality of data lines;
a processor configured to receive first image data for the display panel from the application processor, determine a touch path based on a touch event generated by the touch sensor panel, and output second image data obtained by using the touch path to add overlay data to the first image data;
a gate driver configured to supply a scan signal to the plurality of gate lines;
a data driver configured to supply a data signal corresponding to the second image data to the plurality of data lines according to the scan signal; and
a control signal generating unit configured to generate a control signal for controlling an operation timing of the gate driver and the data driver, and operate in an interlace mode when the second image data is output to the display panel to control the gate driver such that the scan signal is supplied to every other line.

7. The electronic device of claim 6, wherein the processor includes:
a touch path logic configured to receive the touch event, determine the touch path based on the touch event, and generate mask data using the touch path; and
a rendering logic configured to receive the first image data from the application processor and output the second image data obtained by using the mask data generated from the touch path to add the overlay data to the first image data.

8. The electronic device of claim 7, wherein:
the mask data includes a matrix of a plurality of numerical values,
positions of the numerical values of the matrix correspond to positions of pixels in the second image data, and
each numerical value specifies an overlay operation in a corresponding pixel.

9. The electronic device of claim 6, wherein the processor and the control signal generating unit are components of a timing controller.

10. A method for driving a display device comprising:
receiving a touch event generated on a touch panel;
generating an touch path based on the touch event;
generating mask data from the touch path;
receiving first image data from an external system;
generating a second image data obtained by combining overlay data to the first image data according to the mask data; and
displaying the second image data in an interlace mode.
